(19) United States
(12) Patent Application Publication
(10) Pub. No.: US 2008/0001983 A1
(43) Pub. Date: Jan. 3, 2008

(54) IMAGE-FORMING APPARATUS AND IMAGE-FORMING METHOD

(75) Inventors: Masato Kawakami, Tokyo (JP); Hiromi Mochizuki, Tokyo (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 11/768,904

(22) Filed: Jun. 26, 2007

(30) Foreign Application Priority Data
Jun. 30, 2006 (JP) 2006-180714

(51) Int. Cl. B41J 29/38; B41J 2/015

(52) U.S. Cl. 347/14; 347/21

(57) ABSTRACT

An image-forming apparatus is provided for formation of a high-quality image without irregularity in the image density independently of the infiltration time of the pretreatment liquid or the delivery speed of the plain paper sheet for the printing. The interval between a pretreatment liquid applicator 30 and printing heads 21-24 is adjusted by a stepping motor 98 driven by a stepping motor control circuit 34 based on the delivery speed data read by a memory controller 68. Thereby an endless belt 90 is allowed to circulate in the direction of the arrow-C or arrow-D. This circulation movement of the endless belt displaces the applicator holder 82 or the pretreatment liquid applicator 30 at an intended distance in the arrow-A direction or the reverse direction along the guide rail 86,88.

### TECHNICAL FIELD

The present invention relates to an image-forming apparatus for forming an image by preliminarily applying a pretreatment liquid onto a surface of a recording medium, and subsequently ejecting an ink onto the pretreatment-liquid-applied recording medium to form an image. The present invention relates also to an image-forming method employing the apparatus.

### BACKGROUND TECHNIQUES

Ink-jet type image-forming apparatuses are widely used which eject ink through an ink-ejection outlet of a printing head onto a recording medium (printing medium) such as a paper sheet, a resin film, a cloth, and a metal to form an image. Ink-jet type image-forming apparatuses have advantages that an image is formed, noiselessly without contact of the printing head with the recording medium, at a high printing speed at a high image density, and color printing can be conducted readily. Therefore the ink-jet type image-forming apparatuses are useful for industrial image formation.

In industrial printing (image formation) by use of the ink-jet type image-forming apparatus, a high speed of the printing is required for printing on a large amount of recording mediums. For the high-speed printing, a full-line type ink-jet printer is used which has a long printing head, so-called a full-line type printing head, having ink ejection outlets arranged over the entire width of the image formation region of the recording medium.

The full-line type ink-jet printer has usually a printing head designed to eject ink droplets perpendicularly to the recording medium face, and forms (prints) an image on a continuously moving recording medium (being delivered). Thereby the full-line type ink-jet printer is capable of printing at a printing speed higher than a so-called serial type ink-jet printer which forms image by scanning the recording medium with the printing head in the direction crossing the delivered recording medium.

In the industrial ink-jet type printing process, images are formed mostly on plain paper sheets (recording medium having no ink-receiving layer for receiving an ink) in view of the running cost. An image printed on a plain paper sheet is insufficient in water-resistance owing to the absence of the ink-receiving layer. Further, on the plain paper sheet, a color image cannot be formed with high print-fastness and high image quality since a high density of the image without ink feathering (running of the ink along the paper fibers) and prevention of bleeding between the colors cannot be achieved simultaneously.

For higher water resistance of the image, inks are used which contain a water-resistant colorant. However, such inks are not sufficient for the water-resistance yet, and tend to clog the nozzles of the printing head owing to the low water-solubility of the dried ink in water, which makes the apparatus constitution complicated for prevention of the ink-clogging, disadvantageously.

To solve the above problems, techniques are disclosed which use an ink (recording liquid) containing aggregate particles consisting of water, a colorant and an aggregating agent for forming high-density images without ink feathering (e.g., Japanese Patent Application Laid-Open No. H10-298469A). However, such techniques have problems of nozzle clogging caused by the aggregating agent in the ink, and are insufficient in long-term storage of the ink.

Serial type ink-jet printers are disclosed which comprise a liquid-applying means for applying a pretreatment liquid containing a substance for insolubilizing or coagulating the colorant of the ink by scanning the recording medium, and a recording means for forming an image by ejecting the ink containing the colorant on the recording medium for forming an image (e.g., Japanese Patent Application Laid-Open No. 2000-218772A). Such techniques are applicable to serial type ink-jet printers, and employ plural nozzles for applying a pretreatment liquid on a recording medium by scanning the recording medium. Even when some of the plural nozzles come to clog not to eject the pretreatment liquid, the pretreatment liquid can be applied onto the entire face of the image formation region of the recording medium by scanning in reciprocation with the liquid-applying means.

Various qualities of plain paper sheets are used for ink-jet printing. The time of infiltration of the pretreatment liquid depends on the quality of the paper sheet. Further the delivery speed of the plain paper may be changed for the image to be printed even when the same quality of the plain paper sheet is used. Furthermore, the time necessary for the infiltration of the pretreatment liquid into the plain paper sheet can vary depending on the kind of the pretreatment liquid.

As mentioned above, the change in the necessary time for infiltration of the pretreatment liquid or the change in the delivery speed of the plain paper sheet causes change in the time interval between infiltration of the pretreatment liquid and the ink ejection (ink dotting). This results in ejection of the ink onto the pretreated area before complete infiltration of the pretreatment liquid into the pretreated area of the recording medium. In such a case, the ink in a droplet state will coagulate in the pretreatment liquid to cause a so-called “polka dot phenomenon” (non-spread dotting phenomenon) which is caused by incomplete infiltration of the ink into the recording medium, not giving dots in an ideal dot shape and resulting in non-uniformity of the image. This phenomenon will be discussed later.

### DISCLOSURE OF THE INVENTION

The present invention intends to provide an image-forming apparatus for forming an image, at a high quality without feathering of the image independently of the time of infiltration of the pretreatment liquid or the speed of delivery of the recording plain paper; and an image-forming method employing the image-forming apparatus.

The image-forming apparatus of the present invention, for achieving the above object, has a pretreatment liquid applicator for applying a pretreatment liquid onto a recording medium being delivered in a delivery direction, and a printing head for ejecting an ink onto the recording medium on which the pretreatment liquid has been applied by the pretreatment liquid applicator:

(1) which comprises an interval-adjusting means for adjusting the interval between the position of application of the pretreatment liquid applicator and the position of the printing head, depending on the delivery speed of the recording medium in the delivery direction.

### (2) The interval-adjusting means may adjust the interval by displacing the position of the pretreatment liquid applicator in the delivery direction or in the reverse direction.

### (3) The interval-adjusting means may adjust the interval by displacing the position of printing head in the delivery direction of in the reverse direction.

### (4) The interval-adjusting means may lengthen the interval to meet an increase of the delivery speed of the recording medium.

### (5) The interval adjusting means may shorten the interval to meet a decrease of the delivery speed of the recording medium.

### (6) The pretreatment liquid applicator for applying the pretreatment liquid may have plural nozzles which discharge respectively the pretreatment liquid in accordance with an electric pulse, and

(7) the controlling means may control the electric pulse to control the amount of the pretreatment liquid ejected from the pretreatment liquid applicator.

### (8) The interval-adjusting means may adjust the interval d (cm) for the delivery speed s (cm/sec) to satisfy Equation 1:

(9) [d×(A₁₁×A₁₂×A₂)]/[s×(B₁₁×B₁₂×B₂)]≧C (Equation 1)

(10) wherein “C” is a constant depending on the kind of the pretreatment liquid; “s” denotes the delivery speed (cm/sec) of the recording medium; “d” denotes the interval (cm) between the pretreatment liquid applicator and the printing head; “A₁₁×A₁₂” denotes a recording density ((dpi)×(dpi)) of an image formed on the recording medium; “A₂” denotes an amount (ng) of the one ink drop ejected from one nozzle of the printing head; “B₁₁×B₁₂” denotes the application density ((dpi)×(dpi)) of pretreatment liquid drops ejected from one nozzle of the pretreatment liquid applicator (corresponding to the recording density) to insolubilize or coagulate the colorant contained in the ink ejected from the printing head; and “B₂” denotes the amount (ng) of the one drop of the pretreatment liquid ejected form one nozzle of the pretreatment liquid applicator.

Further the image-forming apparatus of the present invention may comprise:

(11) a delivery speed detecting means for detecting the delivery speed, and
(12) an interval detecting means for detecting the interval.
(13) The interval-adjusting means may displace the pretreatment liquid applicator or the printing head to make the delivery speed s (cm/sec) detected by the delivery speed detecting means and the interval d (cm) detected by the interval detecting means to satisfy Equation 1.

### (14) The pretreatment liquid applicator may apply a liquid composition having a Bristow's infiltration coefficient of 0.1-3.0 (mL/m²·s^{1/2}) in a recording medium having a Stoeckigt sizing degree of 40-100 (sec) on which the ink is to be ejected.

The image-forming method of the present invention, for achieving the above object forms an image by applying a pretreatment liquid onto a recording medium being delivered in a delivery direction, and subsequently ejecting an ink onto the recording medium on which the pretreatment liquid has been applied,

(15) wherein the interval between the position of application of the pretreatment liquid and the position of ejection of the ink is adjusted depending on the delivery speed of the recording medium.

### (16) The interval may be adjusted by displacing the position of application of the pretreatment liquid in the delivery direction or in the reverse direction.

### (17) The interval may be adjusted by displacing the position of ejection of the ink in the delivery direction of in the reverse direction.

### (18) The interval may be lengthened to meet an increase of the delivery speed of the recording medium.

### (19) The interval may be shortened to meet a decrease of the delivery speed of the recording medium.

### (20) A pretreatment liquid applicator for applying the pretreatment liquid may have plural nozzles for ejecting the pretreatment liquid in accordance with electric pulses, and

(21) the quantity of the ejected pretreatment liquid may be controlled by controlling the electric pulses.

### (22) The interval d (cm) may be adjusted for the delivery speed s (cm/sec) to satisfy Equation 1:

(23) [d×(A₁₁×A₁₂×A₁₂)]/[s×(B₁₁×B₁₂×B₂)]≧C (Equation 1)

(24) wherein “C” is a constant depending on the kind of the pretreatment liquid; “s” denotes the delivery speed (cm/sec) of the recording medium; “d” denotes the interval (cm) between the pretreatment liquid applicator and the printing head; “A₁₁×A₁₂” denotes a recording density ((dpi)×(dpi)) of an image formed on the recording medium; “A₂” denotes an amount (ng) of the one ink drop ejected from one nozzle of the printing head; “B₁₁×B₁₂” denotes the application density ((dpi)×(dpi)) of pretreatment liquid drops ejected from one nozzle of the pretreatment liquid applicator (corresponding to the recording density) to insolubilize or coagulate the colorant contained in the ink ejected from the printing head; and “B₂” denotes the amount (ng) of the one drop of the pretreatment liquid ejected form one nozzle of the pretreatment liquid applicator.

### (25) The delivery speed s (cm/sec) and the interval d (cm) may be detected and

(26) the position of the application and the position of the ejection may be adjusted to satisfy Equation 1.

### (27) The liquid composition to be applied may have a Bristow's infiltration coefficient of 0.1-3.0 (mL/m²·s^{1/2}) in the recording medium having a Stoeckigt sizing degree of 40-100 (sec) onto which the ink is to be ejected.

The pretreatment liquid employed in the present invention is described below. The pretreatment liquid employed in the present invention contains at least a cationic substance. The cationic substance may be a low-molecular cationic substance (1), or a high-molecular cationic substance (2); more preferably the cationic substance is a cationic substance (3) having at least one molecular weight distribution peak respectively in the region of molecular weight of not more than 1,000 and in the region of molecular weight from 1,500 to 10,000 as measured by GPC.

The above low-molecular cationic substance (1) includes salts of primary, secondary and tertiary amines such as hydrochloride salts and acetate salts of dodecylamine, coconut-amine, stearylamine, and rosin-amine; quaternary ammonium salts such as dodecyltrimethylammonium chloride, dodecylbenzyltrimethylammonium chloride, dodecyldimethylbenzylammonium chloride, stearyltrimethylammonium chloride, benzyltributylammonium chloride, benzalconium chloride, and cetyltrimethylammonium chloride; pyridinium salts such as cetylpyridinium chloride, and cetylpyridinium bromide; imidazoline type cationic compounds such as 2-heptadecenyl-hydroxyethylimidazoline; and ethylene oxide adducts of higher alkylamines such as dihydroxyethylstearylamine.

In the present invention, further, ampholytic surfactants are also useful which become cationic in a certain pH region. Specifically, the ampholytic surfactants include carboxylate salt type, sulfate ester type, sulfonic acid type, phosphate ester type of ampholytic surfactants: the carboxylate salt type ampholytic surfactants include specifically amino acid type ampholytic surfactants; R—NH—CH₂—CH₂—COOH type compounds; betaine type compounds such as stearyldimethylbetaine, and dodecyldihydroxyethylbetaine. Naturally, in use of the ampholytic surfactant, the pretreatment liquid is adjusted to be at a pH not higher than the isoelectric point, or to have a pH not higher than the isoelectric point on mixing with an ink on a recording medium. Although the low-molecular cationic compounds are mentioned above as the examples, the compounds are not limited thereto in the present invention, naturally.

The above high-molecular cationic compounds (2) include specifically polyallylamine, polyamine sulfone, polyvinylamine, chitosan, and entirely or partially neutralized products thereof with an acid such as hydrochloric acid and acetic acid, but are not limited thereto.

In the present invention, the above high-molecular cationic compound may be a partially cationized high-molecular nonionic compound, exemplified by a copolymer of vinylpyrrolidone and a quaternary aminoalkyl alkylate salt, and a copolymer of acrylamide and a quaternary aminomethylacrylamide salt, but is not limited thereto naturally. The high-molecular substance or cationic high-molecular substance is preferably water-soluble, but may be in a state of dispersion such as a latex and an emulsion.

The cationic compound (3) mentioned above is described below specifically. The cationic compound having the molecular weight distribution peak in the region of molecular weight of not more than 1,000 may be selected suitably from the above-mentioned low-molecular cationic compounds (1). In the present invention, the cationic compound having the molecular weight distribution peak in the region of molecular weight of not more than 1,000 may be selected from many compounds having nearly a monodisperse molecular weight distribution. A simple compound having no molecular weight distribution is regarded as having its molecular weight distribution peak at the position of the molecular weight corresponding to the chemical formula of the compound.

The cationic compound having the molecular weight distribution peak in the region of the molecular weight from 1,500 to 10,000 may be selected suitably from the above-mentioned high-molecular cationic compounds (2). The cationic compound having the molecular weight distribution peak in the region of molecular weight from 1,500 to 10,000 such as high-molecular polyallylamine gives the effects mentioned above. That is, in the second step of the reaction of the pretreatment liquid with the ink, the high-molecular cationic compound adsorbs the association product of an anionic compound in the dye or pigment ink and the low-molecular cationic compound, or a pigment aggregate to enlarge the size thereof to cause solid-liquid separation and to retard penetration of the dye or pigment of the ink into the interstice of the fibers of the recording medium, whereby the isolated liquid portion only is allowed to infiltrate into the recording medium to achieve simultaneously high-quality and high fixability of the print. In this process, the high-molecular cationic compound having at least one molecular weight distribution peak in the region of molecular weight from 1,500 to 10,000 can achieve the above effect of the present invention. The cationic compound is contained in the pretreatment liquid in an amount ranging from 1 to 10 wt %, preferably from 1 to 5 wt %.

The ink useful in the present invention includes direct dyes, acid dyes, food dyes, basic dyes, reactive dyes, disperse dyes, vat dyes, soluble vat dyes, reactive disperse dyes, oil dyes, and pigments. For safety, aqueous dyes are preferred. For weatherability, aqueous pigment inks are preferred. The content of the recording agent is decided depending on the kind of the liquid medium, and characteristics required for the ink. The content ranges generally from 0.2 to 20 wt %, preferably from 0.5 to 10 wt %, more preferably from 1 to 5 wt %. The organic solvent useful in the present invention includes amides such as dimethylformamide, and dimethylacetamide; ketones and ketoalcohols such as acetone, and diacetone alcohol; ethers such as tetrahydrofuran, and dioxane; oxyethylene or oxypropylene addition polymers such as diethylene glycol, triethylene glycol, tetraethylene glycol, dipropylene glycol, tripropylene glycol, polyethylene glycol, and polypropylene glycol; alkylene glycols such as ethylene glycol, propylene glycol, trimethylene glycol, butylenes glycol, 1,2,6-hexanetriol, and hexylene glycol; thiodiglycol; glycerin; lower alkyl ethers of polyhydric alcohols such as ethylene glycol monomethyl (or monoethyl)ether, diethylene glycol monomethyl (or monoethyl)ether, and triethylene glycol monomethyl (or monoethyl)ether; di-(lower alkyl)ethers of polyhydric alcohols such as triethylene glycol dimethyl (or diethyl)ether, and tetraethylene glycol dimethyl (or diethyl)ether; sulfolane; N-methyl-2-pyrrolidone; and 1,3-dimethyl-2-imidazolidinone. The above-mentioned organic solvent is contained in the ink at a content ranging generally from 1 to 50 wt %, preferably from 2 to 30 wt % based on the total weight of the ink. The above organic solvent may be used singly or as a mixture of two or more thereof. A preferred composition of the liquid medium is composed of water and one or more organic solvents, the organic solvent or solvents containing at least one water-soluble high-boiling solvent such as a polyhydric alcohol like diethylene glycol, triethylene glycol, or glycerin. The liquid medium may contain a resin, a neutralizing agent, or the like for dispersing the pigment.

According to the present invention, the interval between the pretreatment liquid applicator and the printing head can be changed in correspondence with the delivery speed of the recording medium like a plain paper sheet. At a high speed of delivery of the pretreated recording medium, the interval between the pretreatment liquid-applicator and the printing head is lengthened to allow the applied pretreatment liquid to infiltrate completely into the recording medium and to obtain sufficient time before the ink ejection from the printing head onto the recording medium. On the other hand, at a low speed of delivery of the pretreated recording medium, the pretreatment liquid can infiltrate completely into the recording medium even with a shortened interval between the pretreatment liquid-applicator and the printing head. In such a manner, the pretreatment liquid can be allowed to infiltrate completely into the recording medium before the ink droplets impact the recording medium even if the delivery speed of the recording medium is changed. That is, the ink is ejected to form an image on the recording medium where the pretreatment liquid has infiltrated. Thereby, the polka dot phenomenon (non-spread dotting phenomenon) is prevented, and a high-quality image can be formed without irregularity of the image density and ink feathering independently of the time for infiltration of the pretreatment liquid and the speed of the delivery of a plain paper sheet.

### BRIEF DESCRIPTION OF THE DRAWINGS

FIG. 1 is a side view illustrating schematically constitution of a printer as an example of the image-forming apparatus of the present invention.

FIG. 2 is a perspective view of the printer of FIG. 1.

FIG. 3 is a block diagram illustrating a control system of the printer.

FIG. 4(a-1-1) to FIG. 4(b-2) illustrate schematically states of a pretreatment liquid applied on a recording medium and ink ejected thereon. FIGS. 4(a-1-1) to 4(a-1-3) are sectional views showing schematically the states of infiltration of a pretreatment liquid and infiltration of ink deposited thereon. FIG. 4(a-2) is a plan view of the recording medium after deposition of the ejected ink droplets on the recording medium. FIGS. 4(b-1-1) to 4(b-1-3) show a comparative example, illustrating state of deposition of ejected ink droplet before the pretreatment liquid infiltrates completely into the recording medium. FIG. 4(b-2) is a plan view of the recording medium of FIG. 4(b-1) after deposition of the ejected ink droplets on the recording medium.

FIG. 5 is a perspective view illustrating an interval-adjusting means of the present invention.

FIG. 6 is a perspective view illustrating another interval-adjusting means of the present invention.

FIG. 7 is a flow chart illustrating a process for image formation with adjustment of the interval between the position of application of the pretreatment liquid and the position of the ink ejection on the recording medium.

FIG. 8 is a flow chart illustrating another process for image formation with adjustment of the interval between the position of application of the pretreatment liquid on the recording medium and the position of the ink ejection.

FIG. 9 is a schematic plan view of the printer of Example 2.

FIG. 10 is a schematic plan view of the printer of Example 3.

FIG. 11 is a schematic plan view of the printer of Example 4.

### BEST MODE FOR CARRYING OUT THE INVENTION

The present invention has been made practical with a printer which forms an image on a recording medium after application of a pretreatment liquid for insolubilizing a colorant in the ink on the recording medium like a corrugated paper board.

### Example 1

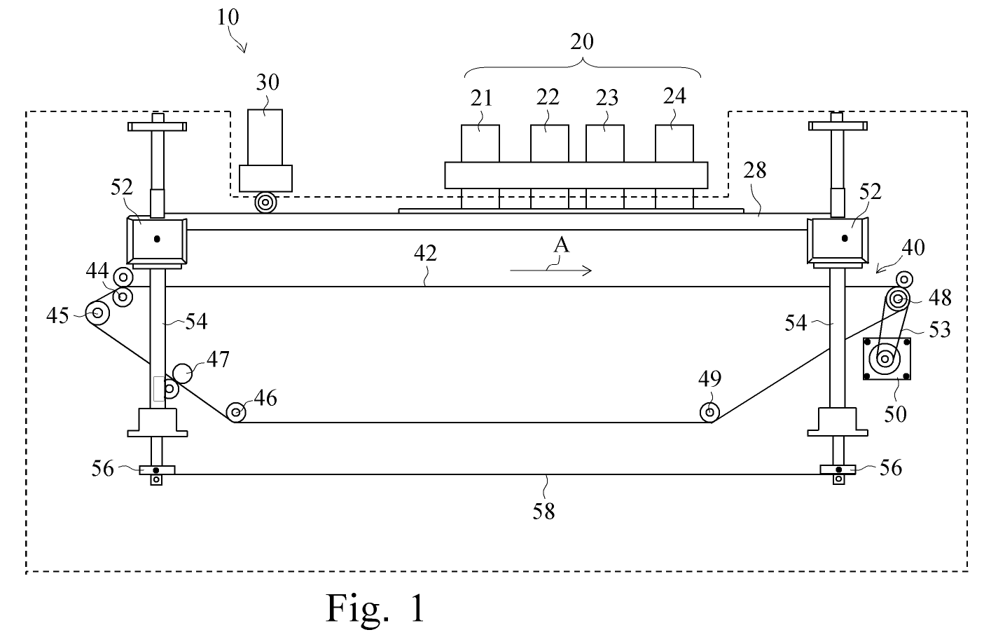

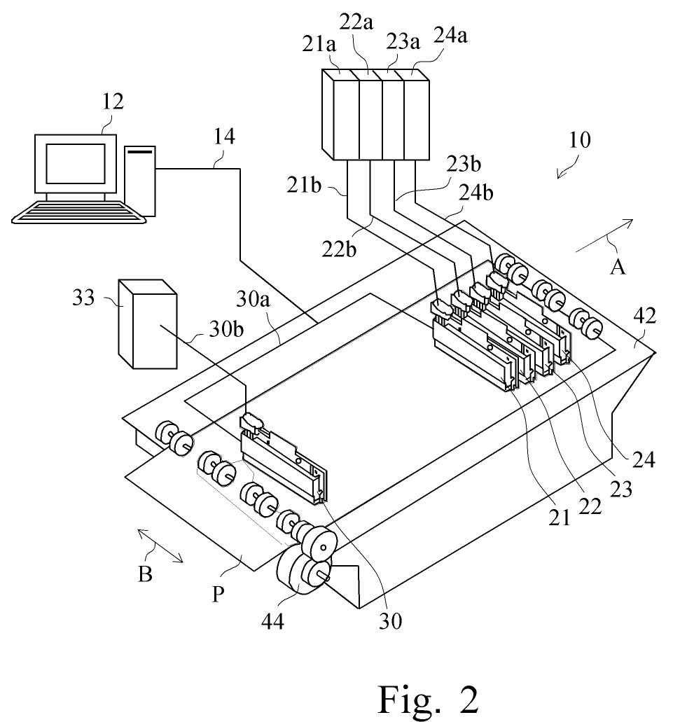

An image-forming apparatus of the present invention is described below with reference to FIGS. 1 and 2.

FIG. 1 is a side view illustrating schematically constitution of a printer as an example of the image-forming apparatus of the present invention. FIG. 2 is a perspective view of the printer shown in FIG. 1.

The printer 10 comprises a printing head unit 20 having printing heads 21,22,23,24 for ejection of an ink to form an image on a recording medium P like a corrugated paper board; a pretreatment liquid applicator (pretreatment liquid-applying head) 30 for applying a pretreatment liquid on the recording medium P; and a delivery unit 40 for delivering the recording medium P in the arrow-A direction (recording medium delivery direction). The printing head 21 ejects a black ink, the printing head 22 ejects a cyan ink, the printing head 23 ejects a magenta ink, and the printing head 24 ejects a yellow ink. The printing head unit 20 is equipped with a head-moving motor (not shown in the drawing) for moving the printing heads 21-24 respectively to positions for capping, printing, and wiping; wiper blades for wiping a dust or a remaining liquid drop off from ink-ejection faces of the printing heads 21-24; and capping mechanisms for capping the printing heads 21-24. The printing head unit 20 is fixed to a flat engine base 28, and is lifted or lowered together with this engine base 28.

The delivery unit 40 has a delivery belt 42 which carries the recording medium to pass below the printing head unit 20. The delivery belts 42 are held by driven rollers 44,45,46 and an encoder roller 47, and driving roller 48. The delivery belts 42 are tensioned by a tensioner 49. A driving motor 50 drives a timing belt 53 to rotate the driving roller 48, and the driving roller drives the delivery belt 42 to turn around in the recording medium delivery direction (arrow-A direction). The driving motor is driven (rotated) to deliver the recording medium at a prescribed speed according to the input data in an information-processor 12 for introducing image information to an encoder roller 47 or printer 10.

The engine base 28 holding the printing head unit 20 is rectangular, and is fixed at its four corners to nuts 52. The nuts 52 are engaged with the screwed shafts 54 and are moved vertically by rotation of the screwed shaft 54. The four screwed shafts 54 (only two of the shafts are shown in the drawing) are respectively connected to a sprocket 56 at the lower end portions. The four sprockets 56 are linked by a chain 58. The screwed shafts 54 are rotated synchronously by driving the chain 58 by a driving motor (not shown in the drawing). Thereby the head unit 20 together with the engine base 28 is moved vertically.

The printing heads 21,22,23,24, the pretreatment liquid applicator 30, and the delivery unit 40 of the printer 10 are connected through a USB cable 14 to an information-processing unit 12 (personal computer) as shown in FIG. 2. Thereby printing data, commands for start or finish of the operation, and other information are transmitted to the printing heads 21,22,23,24 and other units. The information processing unit 12 and the delivery unit 40 exchange signals, through the USB cable 14, for heading of the recording medium P and signals for synchronization of delivery rate and the printing.

The pretreatment liquid applicator 30 extends to cross the recording medium delivery direction (across the paper sheet in the width direction: arrow-B direction in FIG. 2, perpendicular to the face of FIG. 1), and applies the pretreatment liquid onto the face of the recording medium P. A high-quality image can be formed by ejecting ink on the recording medium P on which the pretreatment liquid has been uniformly applied by the pretreatment liquid-applicator. The pretreatment liquid-applicator may be provided in plurality. When two or more pretreatment liquid-applicators are provided, the applicators may be placed successively in the recording medium delivery direction. The pretreatment liquid applicator 30 is connected to a pretreatment liquid tank 33 holding the pretreatment liquid. The pretreatment liquid applicator 30 is of an ink-jet type and applies the pretreatment liquid on the recording medium by ejection of the liquid in droplets. Therefore, the amount of the liquid application can readily be controlled, and the region of the application can be limited to the image-formation region (print area).

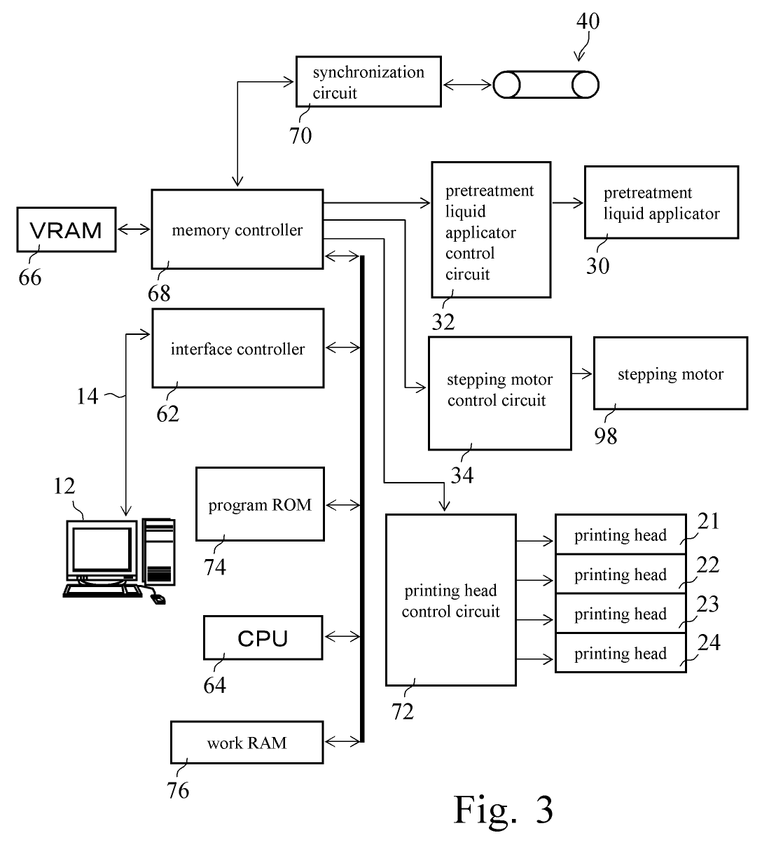

The width of the area (length in the arrow-B direction) onto which the pretreatment liquid is applied by the pretreatment liquid applicator 30 on the recording medium P is larger than the width of the area of ink dotting by the printing heads 21,22,23,24 on the recording medium P. Therefore, all of the ink droplets ejected from the printing heads 21,22,23,24 deposit within the pretreatment liquid-applied area on the recording medium P to form a high-quality image. In this example, the resolution of the pretreatment liquid applicator 30 of the ink-jet system is the same as that of the printing heads 21,22,23,24. However, the resolutions may be made different. Incidentally, the pretreatment liquid applicator 30 is controlled by an applicator control circuit 32 (FIG. 3) as described later.

The printing heads 21,22,23,24 are respectively connected through tubes 21b,22b,23b,24b to ink tanks 21a,22a,23a,24a. Inks are fed respectively from the ink tanks 21a,22a,23a,24a to the printing heads 21,22,23,24. The printing heads 21,22,23,24, when not working for image formation, are capped by a capping mechanism (not shown in the drawing) to prevent drying, clogging, or like inconveniences. Further a sucking mechanism (not shown in the drawing) for sucking the recording medium P like thick card boards to the delivery belt 42 by a vacuum pump or a like device may be provided below the recording medium stage (not shown in the drawing) for delivery of the recording medium P.

The control system of the printer 10 is described below with reference to FIG. 3.

FIG. 3 is a block diagram illustrating a control system of the printer. In FIG. 3 the same numerals are used as in FIGS. 1 and 2 for denoting the corresponding constituent elements.

Print data (recording data) are transmitted from the information processing unit 12 through a USB cable 14 to an interface controller 62. The print data introduced to the interface controller 62 is transmitted to CPU 64. The CPU 64 analyzes the command transmitted from the USB interface, and gives indication to VRAM 66 for bitmap development of image data for respective color components of the recording data. According to this indication, a memory controller 68 writes the image data transmitted from the interface controller 62 to the VRAM 66 at a high speed simultaneously with this writing, the pretreatment liquid applicator control circuit 32 reads the region and amount of the pretreatment liquid applied by the pretreatment liquid applicator 30 corresponding to the image data for the respective colors.

The delivery unit 40 transmits, to a synchronization circuit 70, a heading signal of the recording medium P and a positional pulse signal in synchronization with the movement of the recording medium P. The synchronization circuit 70 synchronizes the received heading signal and positional pulse signal by a system clock (not shown in the drawing). In synchronization with the positional pulse, the data in the VRAM 66 is read out by a memory controller 68 at a high speed, and the read-out data is transmitted through the pretreatment liquid applicator controlling circuit 32 to the pretreatment liquid applicator 30. The pretreatment liquid applicator 30 ejects the pretreatment liquid in accordance with the transmitted data. That is, the pretreatment liquid applicator 30 ejects the pretreatment liquid under control by the pretreatment liquid applicator-controlling circuit 32.

The pretreatment liquid applicator 30 has the same construction as that of the printing heads 21-24, having plural nozzles for ejecting respectively the pretreatment liquid. The plural nozzles have respectively a heating element (not shown in the drawing) controlled (turned on and off) by a pretreatment liquid applicator control circuit 32. The pretreatment liquid is ejected through the nozzles by energizing the heating elements. The pretreatment liquid applicator control circuit 32 controls the respective heating elements independently. Thereby, the pretreatment liquid is ejected through selected nozzles by controlling the quantity of the pretreatment liquid from the pretreatment liquid applicator 35.

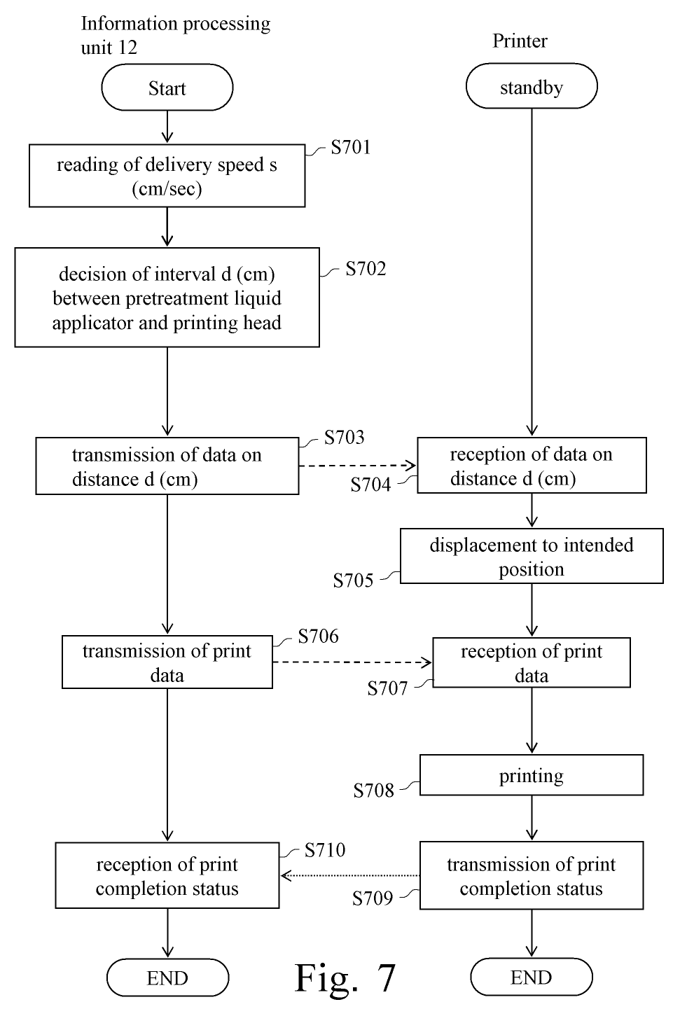

The data read out by the memory controller 68 is transmitted through a printing head control circuit 72 to printing heads 21-24. The printing heads 21-24 eject ink onto the recording medium P in accordance with the transmitted data to form an image on the recording medium P. Incidentally, the CPU 64 works in synchronization with the positional pulse signal according to the processing program memorized in a program ROM 74. This processing program corresponds, for example, to the steps shown in FIG. 7 as a flow chart. The CPU 64 utilizes the work RAM 76 as a working memory.

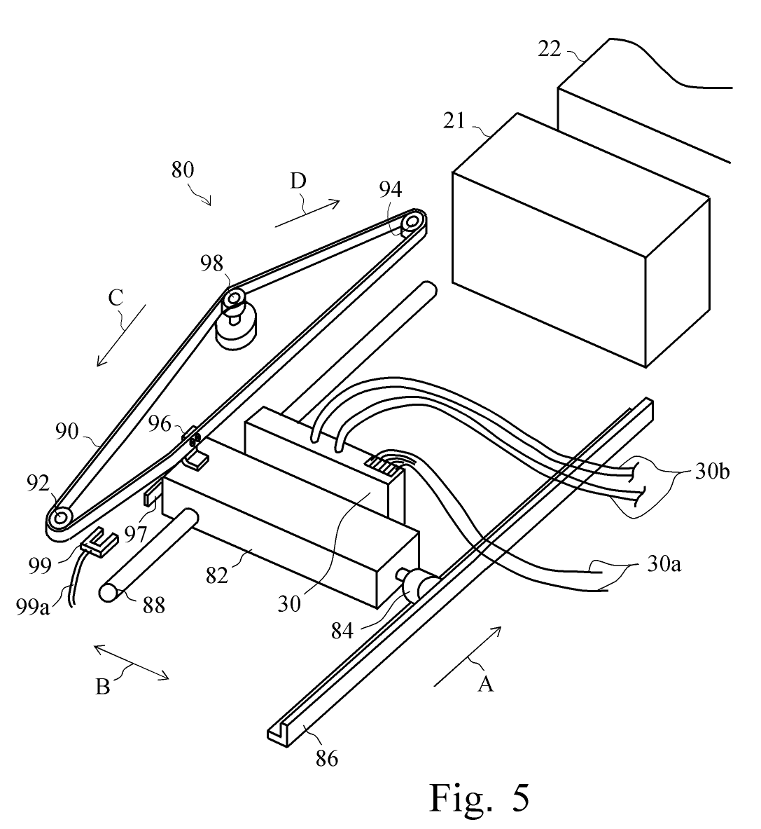

As described above, the pretreatment liquid applicator 30 ejects a pretreatment liquid under control by the pretreatment liquid applicator control circuit 32. This pretreatment liquid applicator 30 is displaceable in the delivery direction (the arrow-A direction in FIGS. 1 and 2) and the reverse direction depending on the delivery speed of the recording medium. This displacement is conducted by driving a stepping motor 98 (FIG. 5). The stepping motor 98 is controlled by a stepping motor control circuit 34. The data read by a memory controller 68 (data for delivery speed of the recording medium P) is transmitted to the stepping motor control circuit 34. The stepping motor control circuit 34 controls the stepping motor 98 in accordance with the transmitted data on delivery speed. By this control, the pretreatment liquid applicator 30 is displaced in the delivery direction of the recording medium P (the arrow-A direction in FIG. 1) or the reverse direction.

A stepping motor control circuit 34 controls the stepping motor 98 to move the pretreatment liquid applicator 30 to allow the pretreatment liquid to infiltrate entirely into the recording medium P before the ink is ejected from the printing heads 21-24 to impact against the area having been pretreated with the pretreatment liquid. Specifically, when the speed of delivery of the recording medium P is higher, the pretreatment liquid applicator 30 is displaced to lengthen the interval between the pretreatment liquid applicator 30 and the printing head 21 (to bring the pretreatment liquid applicator to be more distant from the printing head 21). On the other hand, when the speed of delivery of the recording medium P is lower, the pretreatment liquid applicator 30 is displaced to shorten the interval between the pretreatment liquid applicator 30 and the printing head 21 (to bring the pretreatment liquid applicator 30 nearer to the printing head 21).

In such a manner, the pretreatment liquid applicator 30 is displaced in the arrow-A direction (FIG. 2) or the reverse direction by the stepping motor 98 controlled by the stepping motor control circuit 34 to be suitable for the delivery speed of the recording medium P. Thereby, the pretreatment liquid will infiltrate entirely into the recording medium P before the ink is ejected from the printing heads 21-24 onto the pretreatment liquid-applied area of the recording medium P. Otherwise, the printing head unit 20 (i.e., printing heads 21,22,23,24) may be displaced in the delivery direction (in the arrow-A direction in FIGS. 1 and 2) or the reverse direction according to the delivery speed of the recording medium P. In this constitution, the pretreatment liquid applicator 30 may be displaced as mentioned above or fixed not to be displaced. The displacement constitution is described later. The stepping motor control circuit 34 and the stepping motor 98 are constituent elements of the interval-adjusting means of the present invention. Other constituent elements are described later.

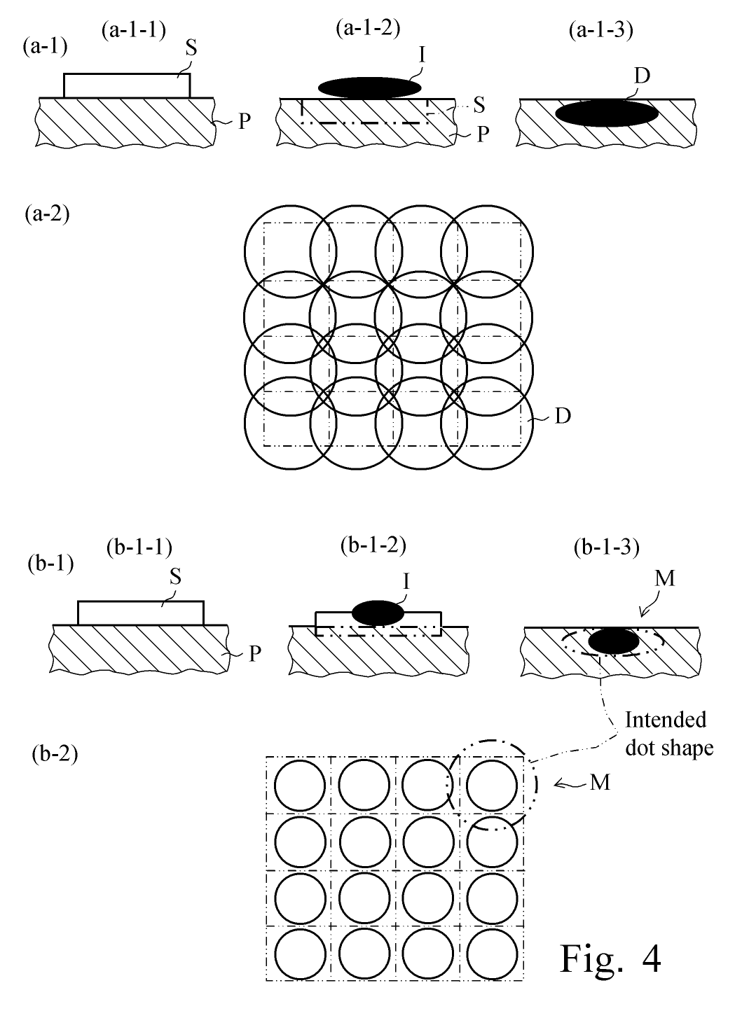

Polka dot phenomenon (non-spread dotting phenomenon) can occur when the ink is ejected from the printing heads 21-24 to deposit on the area of the recording medium P where the pretreatment liquid ejected from the pretreatment liquid applicator 30 has not infiltrated entirely. This phenomenon is described below with reference to FIGS. 4(a-1-1) to 4(b-1-3).

FIGS. 4(a-1-1) to 4(b-2) illustrate schematically the behavior of a pretreatment liquid applied on a recording medium and of an ink ejected thereon. FIGS. 4(a-1-1) to 4(a-1-3) are sectional views showing schematically infiltration of a pretreatment liquid, and behavior of an ink drop deposited thereon after complete infiltration of the pretreatment liquid into the recording medium. FIG. 4(a-2) is a plan view of the recording medium after deposition of the ejected ink droplets on the recording medium. FIGS. 4(b-1-1) to 4(b-1-3) illustrate a comparative example, illustrating the behavior of an ink droplet deposited before the pretreatment liquid infiltrates entirely into the recording medium. FIG. 4(b-2) is a plan view of the recording medium shown in FIG. 4(b-1-3) after deposition of the ejected ink droplets on the recording medium.

In FIGS. 4(a-1-1) to 4(a-a-3) and FIGS. 4(b-1-1) to 4(b1-3), a drop of the pretreatment liquid is applied (deposited) in the same amount (in the same thickness) on the respective recording mediums. The wording “application of a drop of the pretreatment liquid” herein signifies ejection of the pretreatment liquid on the recording medium P through respective the nozzles of the pretreatment liquid applicator 30 (FIG. 1, etc.) capable of ejecting selectively the pretreatment liquid similarly as the ink-jet system.

In FIGS. 4(a-1-1) to 4(a-1-3) and FIG. 4(a-2) the delivery speed of the recording medium P is appropriate. In this case, as illustrated in FIG. 4(a-1-1), the pretreatment liquid S is applied by a pretreatment liquid applicator 30 (FIG. 1, etc.) onto the recording medium P: the applied pretreatment liquid S has entirely infiltrated at the time when the ink droplet I impacts against the recording medium P as illustrated in FIG. 4(a-1-2) since the delivery speed of the recording medium is appropriate. That is, the drop of the pretreatment liquid S entirely infiltrates into the recording medium P before the ink droplet I impacts against the recording medium P. As the result, an ink dot D is formed in a desired dot shape for image formation on the recording medium P as shown in FIG. 4(a-1-3) to form a high-quality image as shown in FIG. 4(a-2).

In another case where the delivery speed of the recording medium P is high (higher than the appropriate speed mentioned above), as shown in FIGS. 4(b-1-1) to 4(b-1-3) and FIG. 4(b-2), the pretreatment liquid S is applied from a pretreatment liquid applicator 30 (FIG. 1, etc.) on the recording medium P similarly as above before the ejection of the ink droplet I through the printing heads 21-24 on to the recording medium P. In this case however, since the delivery speed of the recording medium P is high, the applied pretreatment liquid S has not entirely infiltrated at the time of impact of the ink droplet I against the recording medium as illustrated in FIG. 4 (b-1-2). That is, the pretreatment liquid S does not entirely infiltrate into the recording medium P before the ink droplet I impacts against the recording medium P. As the result, the formed ink dot D does not have an intended dot shape on the recording medium P as shown in FIG. 4(b-1-3) to cause a so-called “polka dot phenomenon M” (non-spread dotting phenomenon) as illustrated in FIG. 4(b-2).

Even in the case where the delivery speed of the recording medium P is as high as that corresponding to FIGS. 4(b-1-1) to 4(b-1-3), the “polka dot phenomenon (non-spread dotting phenomenon)” can be prevented by displacing the pretreatment liquid applicator 30 in the arrow-A direction or reverse direction to increase the distance of the pretreatment liquid applicator 30 (FIG. 1, etc.) from the printing head 21 to secure the time for complete infiltration of the pretreatment liquid into the recording medium P. Thereby the intended shape of the dot D is formed to obtain a high-quality image.

An example of the interval-adjusting means is described for adjusting the interval between pretreatment liquid applicator 30 and the printing head 21 by displacing the pretreatment liquid applicator 30 (FIG. 1, etc.).

FIG. 5 is a perspective view illustrating an interval-adjusting means of the present invention. In FIG. 5, the same numerals and symbols are used as in FIGS. 1 and 2 for denoting the corresponding constituent elements.

An interval-adjusting mechanism 80 (an example of the interval-adjusting means of the present invention) displaces a pretreatment liquid applicator 30 in the arrow-A direction or the reverse direction to adjust the interval between the pretreatment liquid applicator 30 and the printing heads 21-24. The interval adjusting mechanism 80 displaces the applicator holder 82 together with the pretreatment liquid applicator 30 held demountably thereon in the arrow-A direction or reverse direction. The pretreatment liquid applicator 30 is in a shape of a rectangle extending in the paper width direction (arrow-B direction), and the applicator holder 82 extends in the paper sheet width direction longer than the pretreatment liquid applicator 30.

At the one lengthwise end of the applicator holder 82, a roller 84 is attached rotatably. This roller 84 is moved with rotation in the arrow-A direction along a guide rail 86 having an L-shaped cross-section and extending in the arrow-A direction. At the other lengthwise end of the applicator holder 82, a guide rail 88 in a shape of a round bar is allowed to penetrate through the holder 82. This guide rail extends in the arrow-A direction to guide the applicator holder 82 in the arrow-A direction. On the opposite side across the guide rail 88, an endless belt 90 is provided extending in the arrow-A direction. A lengthwise end of the applicator holder 82 is connected to the endless belt 90 by a fixing member 96. The endless belt 90 is connected to two pulleys 92,94 placed at the upstream side and at the downstream side in the arrow-A direction. A stepping motor 98 is placed between the two pulleys 92,94 to circulate the endless belt 90 in the arrow-C direction or the arrow-D direction. The stepping motor 98 is controlled by the stepping motor control circuit 34 (FIG. 3) as mentioned above.

The applicator holder 82 has a plate-shaped flag projecting upstream in the arrow-A direction near the fixing member 96. This flag 97 turns on and off a photo-interrupter 99 placed at the upstream side in the arrow-A direction (at the home position of applicator holder 82). This on-off state indicates the presence or absence of the applicator holder 82 and pretreatment liquid applicator 30 at the home position. The signal from the photo-interrupter 99 is transmitted through a signal line 99a to the stepping motor control circuit 34 to indicate the position of the applicator holder 82 and the pretreatment liquid applicator 30.

Signal lines 30a are connected to the pretreatment liquid applicator 30 to transmit signals from the pretreatment liquid applicator control circuit 32 (FIG. 3). Feeding tubes 30b are connected to the pretreatment liquid applicator 30 for feeding the pretreatment liquid from a pretreatment liquid tank 33 (FIG. 2).

The interval between the pretreatment liquid applicator 30 and the printing heads 21-24 is adjusted by driving the stepping motor 98 under control by the stepping motor control circuit 34 in accordance with the delivery speed data read out by the memory controller 68 as described above. The motor allows the endless belt 90 to circulate in the direction of the arrow-C or arrow D. Thereby, the applicator holder 82 and the pretreatment liquid applicator 30 are moved together along the guide rails 86,88 in the arrow-A direction or reverse direction at a required distance.

The interval between the pretreatment liquid applicator 30 and the printing heads 21-24 can be adjusted to be suitable for the delivery speed of the recording medium P like a plain paper sheet as described above. At a higher delivery speed of the recording medium P having been treated with the pretreatment liquid, the interval between the pretreatment liquid applicator 30 and the printing heads 21-24 is lengthened to obtain an enough time for complete infiltration of the pretreatment liquid having been applied on the recording medium. Thereby, the ink is ejected from the printing heads onto the recording medium P after complete infiltration of the pretreatment liquid into the recording medium P. In contrast, at a lower delivery speed of the recording medium P having been treated with the pretreatment liquid, the interval between the pretreatment liquid applicator 30 and the printing heads 21-24 can be shortened with an enough time kept for complete infiltration of the pretreatment liquid into the recording medium. Thereby, the ink is ejected from the printing heads 21-24 onto the recording medium P after complete infiltration of the pretreatment liquid into the recording medium P. In such a manner, even when the delivery speed of the recording medium P is changed, the pretreatment liquid is allowed to infiltrate entirely into the recording medium P before the ink impacts against the recording medium P. Thus the ink is ejected to form an image from the printing heads 21-24 onto the recording medium P after complete infiltration of the pretreatment liquid. Consequently, the image can be formed, without occurrence of the polka dot phenomenon (non-spread dotting phenomenon) which can be caused by incomplete infiltration of the pretreatment liquid, in a high image quality with uniform image density without ink running, even when the delivery speed of the recording medium P is changed.

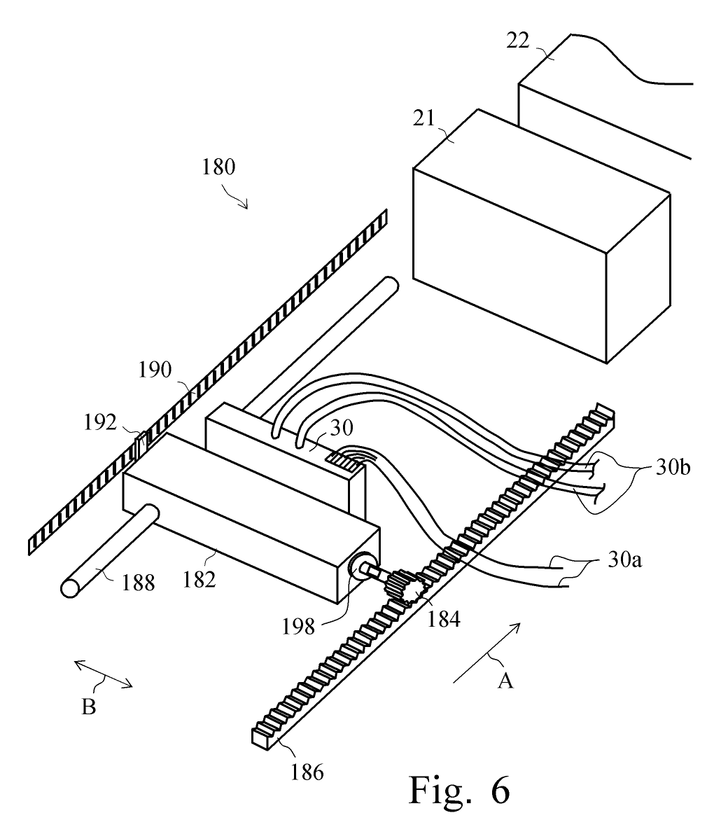

Another example of the interval-adjusting means of the present invention is described below with reference to FIG. 6.

FIG. 6 is a perspective view illustrating another interval-adjusting means of the present invention. In FIG. 6, the same symbols and numerals as in FIGS. 1 and 2 are used for denoting corresponding constituent elements.

An interval-adjusting mechanism 180 (an example of the interval-adjusting means of the present invention) displaces a pretreatment liquid applicator 30 in the arrow-A direction or the reverse direction to adjust the interval between the pretreatment liquid applicator 30 and the printing heads 21-24. The interval adjusting mechanism 180 displaces the applicator holder 182 together with the pretreatment liquid applicator 30 held demountably thereon in the arrow-A direction or the reverse direction. The pretreatment liquid applicator 30 is in a shape of a rectangle extending in the paper sheet width direction (arrow-B direction), and the applicator holder 182 extends in the paper width direction longer than the pretreatment liquid applicator 30.

At the one lengthwise end of the applicator holder 182, a pinion gear 184 is attached rotatably. This pinion gear 184 is engaged with a rack 186 extending in the arrow-A direction, and is connected fixedly to the rotation shaft of a stepping motor 198 to be rotated by the stepping motor 198. The stepping motor 198 is controlled by a stepping motor control circuit 34 (FIG. 3).

At the other lengthwise end of the applicator holder 182, a guide rail 188 in a shape of a round bar is allowed to penetrate through the holder 182. This guide rail extends in the arrow-A direction to guide the applicator holder 182 in the arrow-A direction. On the side opposite to the rack 186 across the guide rail 188, a photo-encoder 190 is provided. Reading of the encoder 190 detected by a reading sensor 192 fixed to the applicator holder 182 indicates the position of the pretreatment liquid applicator 30, and this reading gives the interval between the printing head 21 and the pretreatment liquid applicator 30.

The interval between the pretreatment liquid applicator 30 and the printing heads 21-24 is adjusted by driving the stepping motor 198 under control by the stepping motor control circuit 34 in accordance with the delivery speed data read out by the memory controller 68 as described above. The motor rotates the pinion gear 184 engaging with the rack 186 to displace the applicator holder 182 and the pretreatment liquid applicator 30 together along the guide rail 188 in the arrow-A direction or reverse direction at a required distance.

The interval between the pretreatment liquid applicator 30 and the printing heads 21-24 can be adjusted to be suitable for the delivery speed of the recording medium like a plain paper sheet P as described above. At a higher delivery speed of the recording medium P having been treated with the pretreatment liquid, the interval between the pretreatment liquid applicator 30 and the printing heads 21-24 is lengthened to obtain an enough time for complete infiltration of the pretreatment liquid into the recording medium. Thereby, the ink is ejected from the printing heads onto the recording medium P after complete infiltration of the pretreatment liquid into the recording medium P. In contrast, at a lower delivery speed of the recording medium P having been treated with the pretreatment liquid, the interval between the pretreatment liquid applicator 30 and the printing heads 21-24 can be shortened with an enough time kept for complete infiltration of the pretreatment liquid into the recording medium. Thereby, the ink is ejected from the printing heads 21-24 onto the recording medium P after complete infiltration of the pretreatment liquid into the recording medium P. In such a manner, even when the delivery speed of the recording medium P is changed, the pretreatment liquid is allowed to infiltrate entirely into the recording medium P before the ink drop impacts against the recording medium P. Thus the ink is ejected to form an image from the printing heads 21-24 onto the recording medium P after complete infiltration of the pretreatment liquid. Consequently, the image can be formed, without occurrence of the polka dot phenomenon (non-spread dotting phenomenon) which can be caused by incomplete infiltration of the pretreatment liquid, in a high image quality with uniform image density without ink running, even when the delivery speed of the recording medium P is changed.

The required interval between the pretreatment liquid applicator 30 and the printing head 21 depends on the delivery speed of the recording medium P as mentioned below.

In the description below, the symbols denote the followings: “s”, the delivery speed (cm/sec) of the recording medium P; “d”, the interval (cm) between the pretreatment liquid applicator and the printing head 21; “A₁₁×A₁₂”, the recording density ((dpi)×(dpi)) of an image formed on the recording medium; “A₂”, the amount (ng) of the one ink drop ejected from one nozzle of the printing head 21; “B₁₁×B₁₂”, the application density ((dpi)×(dpi)) of pretreatment liquid drops ejected from one nozzle of the pretreatment liquid applicator 30 (corresponding to the recording density) to insolubilize or coagulate the colorant contained in the ink ejected from the printing head 21; and “B₂”, the amount (ng) of one drop of the pretreatment liquid ejected form one nozzle of the pretreatment liquid applicator 30.

The interval “d” is adjusted to satisfy the relation represented by Equation 1 below.

[d×(A₁₁×A₁₂×A₂)]/[s×(B₁₁×B₁₂×B₂)]≧1.4 (Equation 1)

(In Equation 1, the value of “1.4” is an example, and depends on the kind of the pretreatment liquid.) An example of the pretreatment liquid is a liquid composition having a Bristow's infiltration coefficient of 0.1-3.0 (mL/m²·s^{1/2}) in a recording medium P of a Stoeckigt sizing degree of 40-100 (sec) on which the ink is to be ejected from the printing head 21. This property signifies that the pretreatment liquid is less penetrative into the recording medium.

In this example, the pretreatment liquid was applied in a 100% solid application state at A₁₁×A₁₂ of 300 (dpi)×300 (dpi) and A₂ of 120 (ng), and the ink was applied in a 100% solid printing state at B₁₁×B₁₂ of 300 (dpi)×300 (dpi) and B₂ of 120 (ng). In the printing, the interval d (cm) was varied in the range from 10 cm to 130 cm, and the delivery speed s (cm/sec) was selected at the levels of 16, 32, 64, and 128 (cm/sec). Thereby, the value of Equation 1 (approximate values) and occurrence of the polka dot phenomenon (non-spread dotting phenomenon) were examined. Table 1 shows the results.

In Table 1, in the item of evaluation by Equation 1, the numerals indicate approximate values derived by assigning the above values into Equation-1. The evaluation item M in Table 1 indicates occurrence of the polka dot phenomenon (non-spread dotting phenomenon) described with reference to FIG. 4: “Good” indicating non-occurrence of the polka dot phenomenon, and “Poor” indicating occurrence of the polka dot phenomenon.

As shown in Table 1, at a high delivery speed s, the “polka dot phenomenon” can be prevented by lengthening the interval d. However, at a higher delivery speed s, (e.g., at 128 cm/sec), the polka dot phenomenon cannot be prevented by lengthening further the interval d (e.g., 130 cm).

Table 2 shows the results with another liquid composition (pretreatment liquid) having an infiltration coefficient of 5.0 (mL/m²·s^{1/2}) in a recording medium P of a Stoeckigt sizing degree of 40-100 (sec) on which the ink is to be ejected from the printing heads 21-24. This property of the liquid composition (pretreatment liquid) signifies the high infiltration ability of the liquid into the recording medium.

In Table 2, in the item of evaluation by Equation 1, the numerals indicate approximate values derived by assigning the above values into Equation 1. In the evaluation item M in Table 2, occurrence of the polka dot phenomenon (non-spread phenomenon) is shown: “Good” indicating non-occurrence of the polka dot phenomenon, and “Poor” indicating occurrence of the polka dot phenomenon.

As shown in Table 2, a highly penetrative pretreatment liquid prevents the occurrence of the polka dot phenomenon (non-spread dotting phenomenon). As mentioned with reference to FIG. 4, the polka dot phenomenon is caused by remaining pretreatment liquid on the recording medium surface at the time of impact of the ink drop against the recording medium.

The pretreatment liquid having a high infiltration coefficient rapidly infiltrates completely before the ink drop impacts the recording medium, preventing the polka dot phenomenon in the scope of the present invention.

For preventing the polka dot phenomenon, the data like that shown in Table 1 is derived preliminarily with the pretreatment liquid to be employed in the printer 10, and are memorized in a CPU 64 (FIG. 3), information processing unit 12 (FIG. 2, etc.), or the like. According to the data, the interval d is adjusted depending on the kind of the pretreatment liquid and the delivery speed s by displacing the pretreatment liquid applicator 30, or by displacing the printing heads 21-24 by the mechanism described above with reference to FIGS. 5 and 6.

The delivery speed s may be derived by transmitting the information carrying the delivery speed s from an information processing unit 12 (FIG. 2) to the printer 10 (FIG. 1), or the delivery speed s may be detected by an encoder roller 47 (FIG. 1) placed in the printer 10 (FIG. 1). The interval d can be detected by use of the above photo-encoder 190 and reading sensor 192 (FIG. 6).

A process of image formation is described in which the interval is adjusted between the position of the pretreatment liquid application (position of the pretreatment applicator 30) on the recording medium and the position of the ink ejection (position of the printing head 21).

FIG. 7 is a flow chart illustrating a process for image formation with adjustment of the interval between the position of application of the pretreatment liquid (the position of the pretreatment liquid applicator 30) and the position of the ink deposition (the position of the printing head 21) on the recording medium.

This flow is started by inputting a signal for practicing the printing to an information processing unit 12 (FIG. 3, etc.). To the information processing unit 12, the operator inputs the delivery speed s (cm/sec) predetermined for the respective recording medium (S701). The interval d (cm) between the pretreatment liquid applicator 30 and the printing head 21 is decided depending on the delivery speed s and the kind of the pretreatment liquid (S702). The data on the decided interval d is transmitted to the printer 10 (S703). The printer 10 receives the data on the interval d (S704). According to the data, the pretreatment liquid applicator 30 (FIG. 2) is displaced to have the interval to be at the prescribed interval d (S705). During this displacement, the print data (image information) is transmitted from the information processing unit 12 to the printer 10 (S706). The printer 10 receives the print data (S707), and based on this print data, printing is started (S708) after the displacement of the pretreatment liquid applicator 30. On completion of the printing, a signal of completion of the printing is transmitted from the printer 10 to the information processing unit 12 (S709). On receiving this signal (S710), the printer 10 and the information processing unit 12 stop the flow.

In the above-described process, the printing is started after adjustment of the interval d between the pretreatment liquid applicator 30 and the printing head 21 not to cause the polka dot phenomenon, whereby a high-quality image can be formed by the printer 10 with uniform image density without ink running.

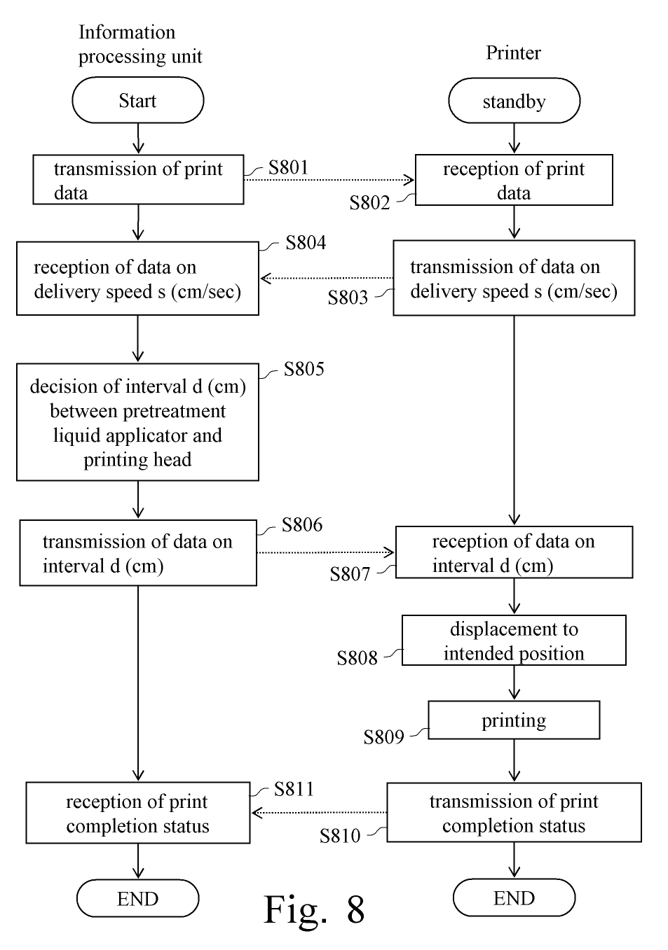

Another process of image formation is described in which the interval between the position of the pretreatment liquid application on the recording medium and the position of the ink ejection is adjusted in another way with reference to FIG. 8.

FIG. 8 is a flow chart illustrating another process for image formation with adjustment of the interval between the position of application of the pretreatment liquid and the position of the ink deposition on the recording medium.

This flow is started by inputting a signal for practicing the printing to an information processing unit 12 (FIG. 3, etc.). A print data (image information) is transmitted from an information processing unit 12 to a printer 10 (S801). The printer 10 receives the print data (S802) and decides the delivery speed s (cm/sec) of the recording medium based on the received print data. The decided delivery speed s is transmitted to the information processing unit 12 (S803). The information processing unit 12 decides the interval d (cm) between the pretreatment liquid applicator 30 and the printing head 21 based on the received delivery speed and the kind of the pretreatment liquid (S805). The data on the decided interval d is transmitted to the printer 10 (S806).

The printer 10 receives the data on the interval d (S807). Based on the data, the pretreatment liquid applicator 30 (FIG. 2, etc.) is displaced to have the interval to be at the prescribed interval d (S808). The printing is started (S809) after the displacement of the pretreatment liquid applicator 30. On completion of the printing, a signal of completion of the printing is transmitted from the printer 10 to the information processing unit 12 (S810). On receiving this signal (S811) by the information processing unit 12, the flow is stopped in the printer 10 and the information processing unit 12.

In the above-described process, the printing is started after adjustment of the interval d between the pretreatment liquid applicator 30 and the printing head 21 not to cause the polka dot phenomenon, whereby a high-quality image can be formed by the printer 10 with uniform image density without ink running.

### Example 2

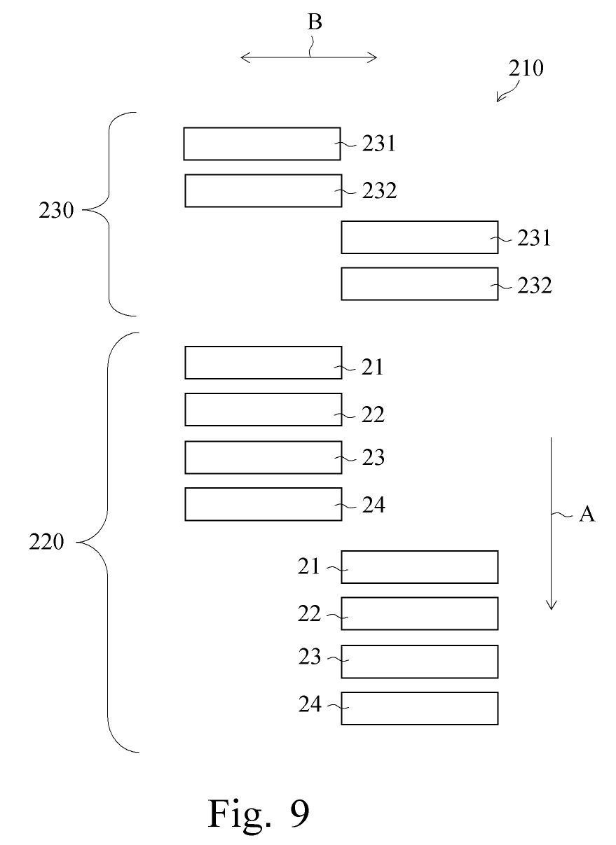

The image-forming apparatus of Example 2 of the present invention is described with reference to FIG. 9.

FIG. 9 is a schematic plan view of the printer of Example 2.

The printer 210 of Example 2 has a pretreatment liquid applicator unit 230 for applying a pretreatment liquid uniformly over a wide recording medium, and a printing head unit 220 for ejecting an ink on an image formation area of the recording medium. The pretreatment liquid applicator unit 230 comprises two sets of pretreatment liquid applicators 231,232 arranged in the delivery direction (arrow-A direction). A first set of the pretreatment liquid applicators 231,232 are placed on the left side in the paper sheet width direction (arrow-B direction) on the face of FIG. 9. A second set of the pretreatment liquid applicators 231,232 are shifted downstream in the delivery direction on the right side of the first set of the pretreatment liquid applicators 231,232 on the face of FIG. 9.

A first group of printing heads 21,22,23,24 corresponding to the first set of the pretreatment liquid applicators 231,232 are placed on the left side of the paper sheet width direction (arrow-B direction) on the face of FIG. 9. The first group of the printing heads 21,22,23,24 eject the ink on the area where the pretreatment liquid has been applied from the first set of the pretreatment liquid applicators 231,232. Similarly, a second group of printing heads 21,22,23,24 corresponding to the second set of the pretreatment liquid applicators 231,232 are placed on the right side of the paper sheet width direction (arrow-B direction) on the face of FIG. 9. The second group of the printing heads 21,22,23,24 eject the ink on the area where the pretreatment liquid has been applied from the second set of the pretreatment liquid applicators 231,232.

As described above, the two sets of the pretreatment liquid applicators 231,232 and the two groups of the printing heads 21,22,23,24 enable formation of a high-quality image even on a recording medium of a large width. In the above printer, the interval d between the pretreatment liquid applicator and the printing head signifies the distance between the pretreatment liquid applicator 232 (on the lower right side in FIG. 9) at the downstream rear side in the arrow-A direction among the plural pretreatment liquid applicators 231,232 and the printing head 21 (on the upper left side in FIG. 9) at the upstream front side in the arrow-A direction among of the plural printing heads 21-24.

### Example 3

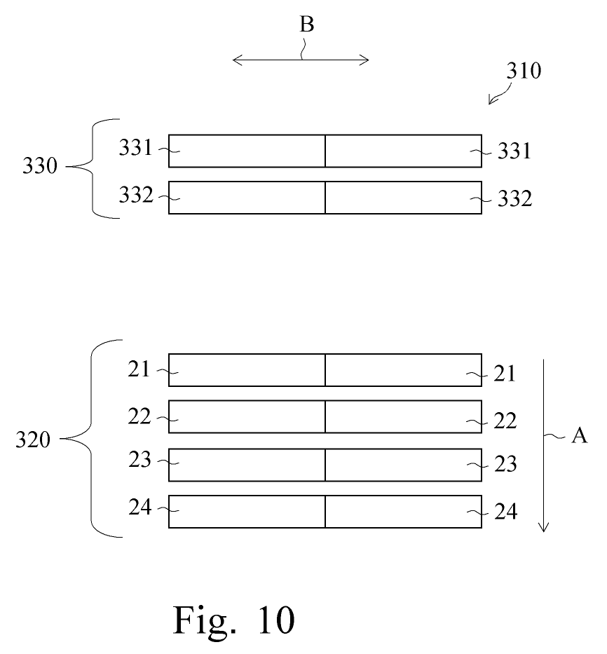

The image-forming apparatus of Example 3 of the present invention is described with reference to FIG. 10.

FIG. 10 is a schematic plan view of the printer of Example 3.

The printer 310 of Example 3 has a pretreatment liquid applicator unit 330 for applying a pretreatment liquid uniformly over a wide recording medium, and a printing head unit 320 for ejecting an ink on an image formation area of the recording medium. The pretreatment liquid applicator unit 330 comprises two sets of pretreatment liquid applicators 331,332 arranged in the delivery direction (arrow-A direction). A first set of the pretreatment liquid applicators 331,332 are placed on the left side in the paper sheet width direction (arrow-B direction) on the face of FIG. 10, and a second set of the pretreatment liquid applicators 331,332 are placed on the right in the paper sheet width direction to be adjacent to the first set of the pretreatment liquid applicators 331,332 on the right side on the face of FIG. 10.

A first group of printing heads 21,22,23,24 corresponding to the first set of the pretreatment liquid applicators 331,332 are placed on the left in the paper sheet width direction (arrow-B direction) on the face of FIG. 10. The first group of the printing heads 21,22,23,24 eject the ink on the area where the pretreatment liquid has been applied from the first set of the pretreatment liquid applicators 331,332. Similarly, a second group of printing heads 21,22,23,24 corresponding to the second set of the pretreatment liquid applicators 331,332 are placed to be adjacent to the first group on the right in the paper sheet width direction (arrow-B direction) on the face of FIG. 10. The second group of the printing heads 21,22,23,24 eject the ink on the area where the pretreatment liquid has been applied from the second set of the pretreatment liquid applicators 231,232.

As described above, the two sets of the pretreatment liquid applicators 331,332 and the two groups of the printing heads 21,22,23,24 enable formation of a high-quality image on a recording medium of a large width. In the above printer, the interval d between the pretreatment liquid applicator and the printing head signifies the distance between the pretreatment liquid applicator 332 (on the lower side in FIG. 10) at the downstream rear side among the pretreatment liquid applicators 331,332 and the printing head 21 at the upstream front side among the printing heads 21-24 (on the upper side in FIG. 10) of the printing heads 21-24.

### Example 4

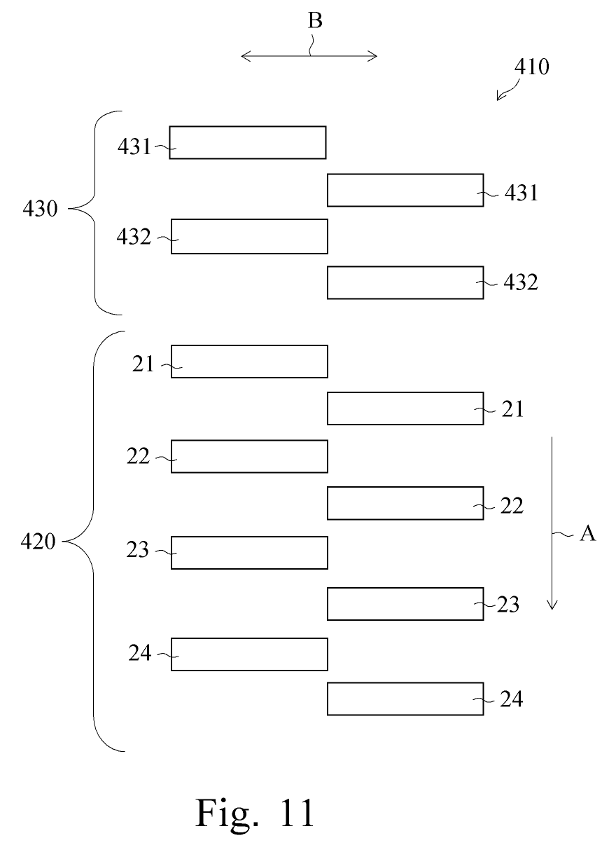

The image-forming apparatus of Example 4 of the present invention is described with reference to FIG. 11.

FIG. 11 is a schematic plan view of the printer of Example 4.

The printer 410 of Example 4 has a pretreatment liquid applicator unit 430 for applying a pretreatment liquid uniformly over a wide recording medium, and a printing head unit 420 for ejecting an ink on an image formation area of the recording medium. The pretreatment liquid applicator unit 430 comprises two sets of pretreatment liquid applicators 431,432 arranged in the delivery direction (arrow-A direction). A first set of the pretreatment liquid applicators 231,232 is placed on the left side in the paper sheet width direction (arrow-B direction) on the face of FIG. 11. A second set of the pretreatment liquid applicators 431,432 is shifted slightly downstream from the first set in the delivery direction on the right side on the face of FIG. 11.

A first group of printing heads 21,22,23,24 corresponding to the first set of the pretreatment liquid applicators 431,432 are placed on the left side in the paper sheet width direction (arrow-B direction) on the face of FIG. 11. The first group of the printing heads 21,22,23,24 eject the ink on the area where the pretreatment liquid has been applied from the first set of the pretreatment liquid applicators 431,432. Similarly, a second group of printing heads 21,22,23,24 corresponding to the second set of the pretreatment liquid applicators 431,432 are placed on the right side of the paper sheet width direction (arrow-B direction) on the face of FIG. 11. The second group of the printing heads 21,22,23,24 eject the ink on the area where the pretreatment liquid has been applied from the second set of the pretreatment liquid applicators 431,432.

As described above, the two sets of the pretreatment liquid applicators 431,432 and the two groups of the printing heads 21,22,23,24 enable formation of a high-quality image even on a recording medium of a large width. In the above printer, the interval d between the pretreatment liquid applicator and the printing head signifies the distance between the pretreatment liquid applicator 432 (on the lower right side in FIG. 11) at the downstream rear side in the arrow-A direction among the pretreatment liquid applicators 431,432 and the printing head 21 (on the upper left side in FIG. 11) at the upstream front side in the arrow-A direction among the printing heads 21-24. This “interval d” signifies the same in the case where only one pretreatment liquid applicator is employed.

TABLE 1

| | | s (cm/sec) | | | | | | | |
|---|---|---|---|---|---|---|---|---|---|
| | | 16 | | 32 | | 64 | | 128 | |
| | | Evaluation item | | | | | | | |
| | | Eq.1 | M | Eq.1 | M | Eq.1 | M | Eq.1 | M |
| d | 10 | 0.6 | Poor | 0.3 | Poor | 0.2 | Poor | 0.1 | Poor |
| (cm) | 20 | 1.3 | Poor | 0.6 | Poor | 0.3 | Poor | 0.2 | Poor |
| | 30 | 1.9 | Good | 0.9 | Poor | 0.5 | Poor | 0.2 | Poor |
| | 40 | 2.5 | Good | 1.3 | Poor | 0.6 | Poor | 0.3 | Poor |
| | 50 | 3.1 | Good | 1.6 | Good | 0.8 | Poor | 0.4 | Poor |
| | 60 | 3.8 | Good | 1.9 | Good | 0.9 | Poor | 0.5 | Poor |
| | 70 | 4.4 | Good | 2.2 | Good | 1.1 | Poor | 0.5 | Poor |
| | 80 | 5 | Good | 2.5 | Good | 1.3 | Poor | 0.6 | Poor |
| | 90 | 5.6 | Good | 2.8 | Good | 1.4 | Good | 0.7 | Poor |
| | 100 | 6.3 | Good | 3.1 | Good | 1.6 | Good | 0.8 | Poor |
| | 110 | 6.9 | Good | 3.4 | Good | 1.7 | Good | 0.9 | Poor |
| | 120 | 7.5 | Good | 3.8 | Good | 1.9 | Good | 0.9 | Poor |
| | 130 | 8.1 | Good | 4.1 | Good | 2 | Good | 1 | Poor |

Eq.1: Value derived from Equation 1
M: Occurrence of polka dot phenomenon
Good: No polka dot formed
Poor: Polka dots formed

TABLE 2

| | | s (cm/sec) | | | | | | | |
|---|---|---|---|---|---|---|---|---|---|
| | | 16 | | 32 | | 64 | | 128 | |
| | | Evaluation item | | | | | | | |
| | | Eq.1 | M | Eq.1 | M | Eq.1 | M | Eq.1 | M |
| D | 10 | 0.6 | Good | 0.3 | Good | 0.2 | Good | 0.1 | Good |
| (cm) | 20 | 1.3 | Good | 0.6 | Good | 0.3 | Good | 0.2 | Good |
| | 30 | 1.9 | Good | 0.9 | Poor | 0.5 | Good | 0.2 | Good |
| | 40 | 2.5 | Good | 1.3 | Good | 0.6 | Good | 0.3 | Good |
| | 50 | 3.1 | Good | 1.6 | Good | 0.8 | Good | 0.4 | Good |
| | 60 | 3.8 | Good | 1.9 | Good | 0.9 | Good | 0.5 | Good |
| | 70 | 4.4 | Good | 2.2 | Good | 1.1 | Good | 0.5 | Good |
| | 80 | 5 | Good | 2.5 | Good | 1.3 | Good | 0.6 | Good |
| | 90 | 5.6 | Good | 2.8 | Good | 1.4 | Good | 0.7 | Good |
| | 100 | 6.3 | Good | 3.1 | Good | 1.6 | Good | 0.8 | Good |
| | 110 | 6.9 | Good | 3.4 | Good | 1.7 | Good | 0.9 | Good |
| | 120 | 7.5 | Good | 3.8 | Good | 1.9 | Good | 0.9 | Good |
| | 130 | 8.1 | Good | 4.1 | Good | 2 | Good | 1 | Good |

Eq.1: Value derived from Equation 1
M: Occurrence of polka dot phenomenon
Good: No polka dot formed
Poor: Polka dots formed

1. A method for image formation by applying a pretreatment liquid onto a recording medium being delivered in a delivery direction, and subsequently ejecting an ink onto the recording medium on which the pretreatment liquid has been applied, wherein the interval between the position of application of the pretreatment liquid and the position of ejection of the ink is adjusted depending on the delivery speed of the recording medium.

2. The method for image formation according to claim 1, wherein the interval is adjusted by displacing the position of application of the pretreatment liquid in the delivery direction or in the reverse direction.

3. The method for image formation according to claim 1, wherein the interval is adjusted by displacing the position of ejection of the ink in the delivery direction of in the reverse direction.

4. The method for image formation according to claim 1, wherein the interval is lengthened to meet an increase of the delivery speed of the recording medium.

5. The method for image formation according to claim 1, wherein the interval is shortened to meet a decrease of the delivery speed of the recording medium.

6. The method for image formation according to claim 1, wherein a pretreatment liquid applicator having plural nozzles is provided for ejecting the pretreatment liquid in accordance with electric pulses, and the quantity of the ejected pretreatment liquid is controlled by controlling the electric pulses.

7. The method for image formation according to claim 6, wherein the interval d (cm) is adjusted for the delivery speed (cm/sec) to satisfy Equation 1:
[d×(A₁₁×A₁₂×A₂)]/[s×(B₁₁×B₁₂×B₂)]≦C (Equation 1)
Wherein “C” is a constant depending on the kind of the pretreatment liquid; “s” denotes the delivery speed (cm/sec) of the recording medium; “d” denotes the interval (cm) between the pretreatment liquid applicator and the printing head; “A₁₁×A₁₂” denotes a recording density ((dpi)×(dpi)) of an image formed on the recording medium; “A₂” denotes an amount (ng) of one ink drop ejected from one nozzle of the printing head; “B₁₁×B₁₂” denotes the application density ((dpi)×(dpi)) of pretreatment liquid drops ejected from one nozzle of the pretreatment liquid applicator to insolubilize or coagulate the colorant contained in the ink ejected from the printing head; and “B₂” denotes the amount (ng) of the one drop of the pretreatment liquid ejected form one nozzle of the pretreatment liquid applicator.

8. The method for image formation according to claim 7, wherein the delivery speed s (cm/sec) and the interval d (cm) are detected and the position of the application of the pretreatment liquid and the position of ejection of the ink are adjusted to satisfy Equation 1.

9. The method for image formation according to claim 1, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

10. An apparatus for image formation having a pretreatment liquid applicator for applying a pretreatment liquid onto a recording medium being delivered in a delivery direction, and a printing head for ejecting an ink onto the recording medium on which the pretreatment liquid has been applied, which comprises an interval-adjusting means for adjusting the interval between the pretreatment liquid applicator and the printing head, depending on the delivery speed of the recording medium in the delivery direction.

11. The method for image formation according to claim 2, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

12. The method for image formation according to claim 3, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

13. The method for image formation according to claim 4, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

14. The method for image formation according to claim 5, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

15. The method for image formation according to claim 6, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

16. The method for image formation according to claim 7, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

17. The method for image formation according to claim 8, wherein the pretreatment liquid has a Bristow's infiltration coefficient of 0.1-3.0 (mL/m²·s^{1/2}) in a recording medium having a Stoeckigt sizing degree of 40-100 (sec) on which the ink is to be ejected.

18. The method for image formation according to claim 2, wherein the interval is adjusted by displacing the position of ejection of the ink in the delivery direction of in the reverse direction.

19. The method for image formation according to claim 2, wherein the interval is lengthened to meet an increase of the delivery speed of the recording medium.

20. The method for image formation according to claim 2, wherein the interval is shortened to meet a decrease of the delivery speed of the recording medium.
